(19) United States
(12) Patent Application Publication
(10) Pub. No.: US 2009/0108725 A1
(43) Pub. Date: Apr. 30, 2009

(54) Three-Electrode Surface Discharge Display

(75) Inventors: Hitoshi Hirakawa, Hyogo (JP); Manabu Ishimoto, Hyogo (JP); Kenji Awamoto, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: SHINODA PLASMA CORPORATION, Kobe-shi (JP)

(21) Appl. No.: 12/225,513

(22) PCT Filed: Mar. 23, 2006
(86) PCT No.: PCT/JP2006/305784

§ 371 Date: Sep. 23, 2008

(51) Int. Cl. H01J 61/94; G09G 3/04

(52) U.S. Cl. 313/1; 345/43

(57) ABSTRACT

A three-electrode surface discharge display (1) of the present invention includes: a plurality of parallel discharge tubes (10) to provide a panel-like effective display area (S); a plurality of display electrode pairs disposed on one surface-side of the discharge tubes (10) across the discharge tubes (10), with each display electrode pair composed of a pair of parallel electrodes (X, Y); and addressing electrodes (A) disposed along the discharge tubes on the other surface-side of the discharge tubes (10). A dummy electrode pair, provided outside the effective display area (S) and parallel to the endmost display electrode pair in the effective display area (S), is composed of dummy electrodes (DX, DY) corresponding to the sustaining electrode (X) and the scanning electrode (Y), respectively. The dummy electrode (DY) is electrically connected with the scanning electrode (Y(1)) of the endmost display electrode pair in the effective display area (S).

### TECHNICAL FIELD

The present invention relates to a three-electrode surface discharge display apparatus which is used as a flat panel display for example.

### BACKGROUND ART

A conventional three-electrode surface discharge display apparatus is disclosed in the following Patent Document 1. This display apparatus has a laminate structure in which a plurality of fine discharge tubes are disposed in parallel between a transparent plate on the front side and a plate on the back side, and these plates and the discharge tubes are bonded together with an adhesive for example. Inside each discharge tube, a luminescent layer is provided in a desired area. The front plate has its inward-facing surface formed with a plurality of display electrode pairs each composed of a scanning electrode and a sustaining electrode, which are mutually parallel to each other, spaced from each other by a predetermined distance, in crossing contact with the parallel discharge tubes. The back plate has its inward-facing surface formed with addressing electrodes each of which makes contact along one of the discharge tubes. In each discharge tube, a portion which is crossed by one of the display electrode pairs serves as a light emitting unit (light emitting cell). Each display electrode pair serves as a display line, and a region provided with arrays of these pairs defines a display area.

When displaying an image using a display apparatus of a construction as described, a driving method called address display separation method (ADS method) is employed for gradational display. In the ADS method, a frame (which is a length of display time for an image) is divided into a plurality of sub-fields each having a luminance weight, and each of the sub-fields is composed of a reset period in which electronic charge in all of the light emitting cells is uniformalized; an address period in which light emitting cells to be illuminated are selected; and a sustain period in which the selected light emitting cells are illuminated.

In the reset period, a resetting voltage is applied across the scanning electrode and the sustaining electrode in all of the pairs, whereby any unnecessary charge in each light emitting cell is cancelled. In the address period, a predetermined address pulse voltage is applied to the addressing electrodes in accordance with the display data while a scan pulse voltage is applied sequentially to the scanning electrodes. This generates an addressing discharge between the scanning electrode and the addressing electrode, and a wall charge is accumulated in the desired light emitting cells. In the sustain period, a sustaining pulse voltage is applied alternately to the scanning electrodes and to the sustaining electrodes. As a result, discharge illumination occurs only in those light emitting cells where there is an accumulation of a wall charge. The number of the sustaining pulses in the sustain period is determined in accordance with the luminance weight in the sub-fields.

When a series of operations through these reset period, address period and sustain period is completed, one sub-field is completed. Then, by repeating a predetermined number of the sub-fields, one frame of two-dimensional display is completed, and by repeating this cycle of single-frame display, a motion picture is displayed. Such a driving method as the above allows efficient use of time because selection is made in the address period for those light emitting cells which are supposed to be illuminated, and all of the selected light emitting cells are illuminated at one time.

In driving a three-electrode surface discharge display apparatus, the addressing discharge is executed by sequential application of a scan pulse voltage, and for this reason, the process begins with a display line on one end of the discharge tube and proceeds successively toward a display line on the other end. In the process of successive sequential addressing discharge, there is a sequential supply of charged particles (priming particles) such as electrons and ions generated by the addressing discharge from the previous light emitting cell to the next light emitting cell, and these priming particles serve as a pilot fire (priming effect), thereby ensuring an addressing discharge in each light emitting cell. On the other hand, if there is not enough supply of priming particles from the previous light emitting cell, there is a high risk of a failure in addressing discharge (discharge failure). Since there is no physical supply of priming particles from the previous light emitting cell in the endmost display line where the address period is started, there is a relatively high probability for the discharge failure in this line. When such a discharge failure as described occurs, the light emitting cell which is supposed to emit light does not emit light, resulting in decreased quality of display. In order to solve this problem, one idea may be that the scanning-start line and the adjacent display lines will be covered by a light shielding film and excluded out of the display area, i.e. making these lines serve as so-called dummy lines. In this case, however, addressing operations in the dummy lines make no contribution to light emission yet contribute to relative increase in the length of address period. On the other hand, the time length of one frame is fixed to 16.7 ms ( 1/60 second) in television broadcast for example, and therefore, the longer address period creates a shorter sustain period, which results in decrease in luminance.

Patent Document 1: JP-A-2003-86142

### DISCLOSURE OF THE INVENTION

The present invention has been proposed under the above-described circumstances. The present invention aims at providing a three-electrode surface discharge display apparatus which is capable of efficiently eliminating failure in addressing discharge in the effective display area while reducing time increase in the address period.

In order to solve the above-described problems, the present invention provides the following technical means:

A three-electrode surface discharge display apparatus provided by a first aspect of the present invention includes: a discharge tube group composed of a plurality of discharge tubes extended straightly for a predetermined length in parallel to each other thereby providing a panel as a whole; a plurality of display electrode pairs which are disposed on one surface-side of the discharge tube group across a longitudinal direction of the discharge tubes, where each display electrode pair includes a scanning electrode and a sustaining electrode laid in parallel to each other and spaced by a discharging slit of a predetermined width; and addressing electrodes each disposed along one of the discharge tubes on another surface-side of the discharge tube group. With the above arrangement, each pair of mutually adjacent display electrode pairs provides a display electrode pair slit of a predetermined width, and the discharge tube group and the display electrode pairs provide an effective display area. The three-electrode surface discharge display apparatus further includes a dummy electrode pair which is provided outside the effective display area, along an endmost display electrode pair on a side of the effective display area. The dummy electrode pair includes a first and a second electrodes corresponding to the scanning electrode and the sustaining electrode respectively. The first electrode and the scanning electrode in the endmost display electrode pair are electrically connected with each other.

Preferably, the scanning electrode and the sustaining electrode in each of the display electrode pairs respectively include: a relatively wider transparent electrode; and a relatively narrower and electrically more conductive bus electrode disposed along a far side of the transparent electrode away from the discharging slit. The first and the second electrodes in the dummy electrode pair include a metal electrode which has a better electrical conductivity than the transparent electrode, and the first electrode is wider than the bus electrode.

Preferably, the dummy electrode pair has a discharging slit which is narrower than the discharging slit in the display electrode pairs.

Preferably, the dummy electrode pair has a lower visible light transmissivity than the display electrode pairs.

Preferably, the first electrode and the scanning electrode in the endmost display electrode pair are connected by a wiring.

Preferably, the first electrode and the scanning electrode in the endmost display electrode pair are connected by a drive circuit.

Preferably a gap between the dummy electrode pair and the endmost display electrode pair is narrower than the display electrode pair slit.

Preferably, the first electrode and the scanning electrode in the endmost display electrode pair are disposed adjacently to each other.

A three-electrode surface discharge display apparatus provided by a second aspect of the present invention includes: a discharge light emission element group which is composed of a plurality of discharge light emission elements extended straightly for a predetermined length in parallel to each other thereby providing a panel as a whole; a plurality of display electrode pairs which are disposed on one surface-side of the discharge light emission element group across a longitudinal direction of the discharge light emission elements, where each display electrode pair includes a scanning electrode and a sustaining electrode laid in parallel to each other and spaced by a discharging slit of a predetermined width; and addressing electrodes each disposed along one of the discharge light emission elements on another surface-side of the discharge light emission element group. With the above arrangement, each pair of mutually adjacent display electrode pairs provides a display electrode pair slit of a predetermined width, and the discharge light emission element group and the display electrode pairs provide an effective display area. The three-electrode surface discharge display apparatus further includes a dummy electrode pair which is provided outside the effective display area, along an endmost display electrode pair on a side of the effective display area. The dummy electrode pair includes a first and a second electrodes corresponding to the scanning electrode and the sustaining electrode respectively. The first electrode and the scanning electrode in the endmost display electrode pair are electrically connected with each other.

### BRIEF DESCRIPTION OF THE DRAWINGS

FIG. 1 is an overall perspective view showing a general configuration of a three-electrode surface discharge display apparatus according to the present invention.

FIG. 2 is a perspective view of a primary portion, showing a structure of the display apparatus in FIG. 1.

FIG. 3 is a sectional view of a primary portion, showing a structure of the display apparatus in FIG. 1.

FIG. 4 is a plan view showing an electrode structure in the display apparatus in FIG. 1.

FIG. 5 is a sectional view of a primary portion, showing a structure of the display apparatus in FIG. 1.

FIG. 6 is a drive waveform chart of the three-electrode surface discharge display apparatus according to the present invention.

### BEST MODE FOR CARRYING OUT THE INVENTION

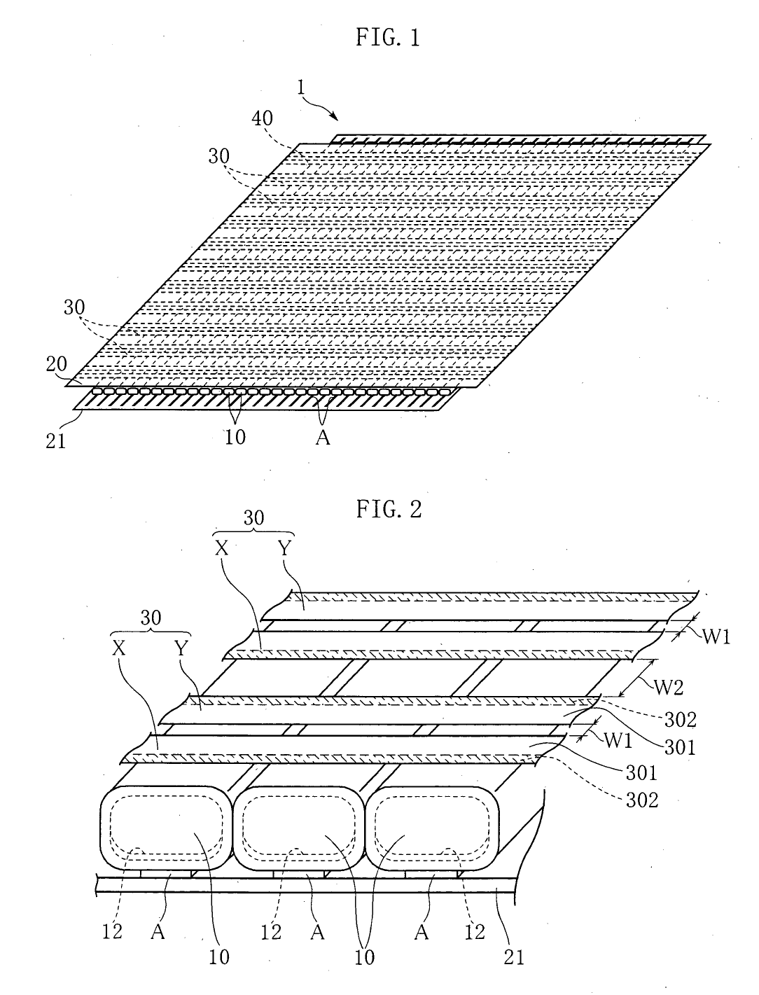

Preferred embodiments of the present invention will be described with reference to the drawings. FIG. 1 through FIG. 5 show a three-electrode surface discharge display apparatus according to the present invention. A display apparatus 1 is a three-electrode surface discharge display apparatus for color display which includes discharge tubes as a discharge light emission element.

As shown in FIG. 1 through FIG. 3, the display apparatus 1 includes a transparent plate 20 on the front side (not illustrated in FIG. 2 for clarity reasons); a plate 21 on the back side; a plurality of discharge tubes 10 disposed in parallel with each other between these plates 20, 21; a plurality of display electrode pairs 30; a dummy electrode pair 40; and a plurality of addressing electrodes A.

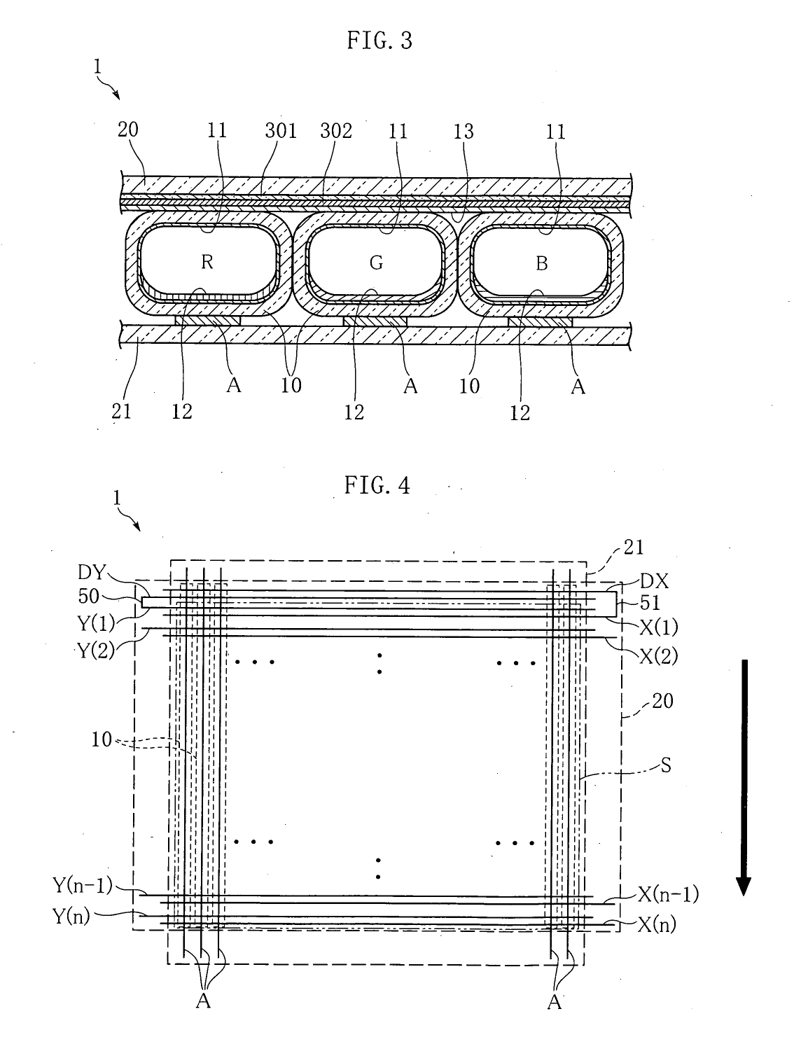

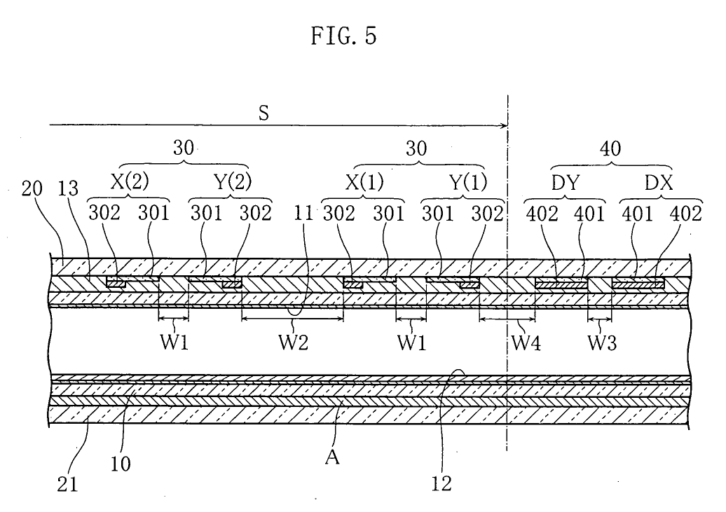

As seen in FIG. 3, the discharge tubes 10 are provided by e.g. long, fine glass tubes which have a generally rectangular section, are sandwiched between the plates 20, 21, and are bonded to the plates 20, 21 via an adhesive and the like. The section of the discharge tube 10 is approximately 1 mm on the long side and approximately 0.5 mm on the short side for example. The discharge tube 10 has a thickness of approximately 0.1 mm for example. The discharge tube 10 has an inner wall surface formed with a uniform MgO film 11 to protect glass whereas the MgO film 11 has a surface formed with a luminescent layer 12. As seen in FIG. 3 or FIG. 5 in more detail, the luminescent layer 12 is formed at a desirable area, which is on the side closer to on the back plate 21. The luminescent layer 12 is provided by a luminescent material for one color of R (red), G (green) and B (Blue), which are the three principal colors for color display. The discharge tube 10 is filled with a discharge gas (a gas mixture of Ne and Xe for example), and the two ends of the discharge tube 10 are sealed. The discharge tubes 10 of the construction as described above are laid sequentially in the order of R, G and B. With the discharge tubes 10 such as described above, an application of a voltage from outside will cause the discharge gas around the site of voltage application to make a local discharge, and vacuum ultraviolet rays generated in this process excite the luminescent layer 12, which in turn emits a visible light of R, G or B.

As seen in FIG. 3, the front and the back plates 20, 21 are platy members formed of a transparent plastic. The front plate 20 is to allow visible lights from the discharge tubes 10 to pass through and thereby come outside as display lights. It should be noted here that the back plate 21 may not be transparent.

The front plate 20 has an inner surface formed with a plurality of display electrode pairs 30 extending laterally across each of the discharge tubes 10. Each display electrode pair 30 is composed of a scanning electrode Y and a sustaining electrode X (see FIG. 2, FIG. 5). The electrodes X, Y in the pair are disposed in parallel to each other at a predetermined distance. The gap between the electrode X and the electrode Y is called discharging slit, and its width W1 is about 300 μm for example. As seen in FIG. 5, the electrodes X, Y are each composed of a transparent electrode 301 formed on the plate 20, and a bus electrode 302 formed on the transparent electrode 301 in a smaller width than that of the transparent electrode 301. The transparent electrode 301, which is to allow the visible lights from the discharge tubes 10 to pass through, is made of a transparent electrode material. The bus electrode 302 is to allow an efficient flow of electric current, and is made of a metal electrode material which has a superior electrical conductivity to the transparent electrode 301. Since the bus electrode 302 does not allow visible lights to pass through, it is formed along a far side of the transparent electrode 301, away from the discharging slit, so as to minimize its blockage of the emitted lights. An example of the material for making the transparent electrode 301 is ITO (Indium Tin Oxide), whereas an example of the material for making the bus electrode 302 is copper and aluminum. The transparent electrode 301 and the bus electrode 302 are formed, for example, by first making a film of an electrode material using a vapor depositing method, spattering method or the like, and then removing unnecessary part by etching. The transparent electrode 301 and the bus electrode 302 may have the following dimensions for example: The transparent electrode 301 may have a thickness of about 0.2 μm and a width of about 850 μm; whereas the bus electrode 302 may have a thickness of 5 μm and a width of about 30 μm.

With the display electrode pairs 30 having such a configuration as described above, portions in each discharge tube 10 crossed by one of the display electrode pairs 30 serve as light emitting units (light emitting cells). Each display electrode pair 30 (one pair of the electrodes X, Y) defines a display line, and the display lines are spaced at a distance in the direction in which the discharge tubes 10 extend. The gap between mutually adjacent display lines (display electrode pairs 30) is called display electrode pair slit, which has a width W2 of about 800 μm for example. In the present embodiment, the number of the display lines is n, and a region in which these n display lines are laid defines an effective display area S.

As seen in FIG. 4 or FIG. 5, the front plate 20 has an inner surface formed with a dummy electrode pair 40 (dummy line) outside of the effective display area S, on one side of the effective display area S (on the upper side as in FIG. 4), in parallel to the display electrode pairs 30 (display lines). The dummy electrode pair 40 is composed of a dummy electrode DY which corresponds to the scanning electrode Y and a dummy electrode DX which corresponds to the sustaining electrode X. The dummy electrodes DX, DY are laid in a different order from the order in which the electrodes X, Y in the display electrode pairs 30 are laid. Specifically, the dummy electrode DY is disposed adjacent to the scanning electrode Y(1).

As shown clearly in FIG. 5, the dummy electrodes DX, DY are each composed of a transparent electrode 401 formed on the plate 20, and a metal electrode 402 formed on the transparent electrode 401. The transparent electrode 401 is formed in the same formation process as for the transparent electrode 301, and is made of the same transparent electrode material as of the transparent electrode 301. Also, the transparent electrode 401 has more or less the same width and thickness as the transparent electrode 301. The metal electrode 402 is formed in the same formation process as for the bus electrode 302, and is made of the same metal electrode material as of the bus electrode 302. The metal electrode 402 has more or less the same thickness as the bus electrode 302. However, the metal electrode 402 has a larger width than the bus electrode 302, and the width is more or less the same as of the transparent electrode 401. The dummy electrode pair 40 has a discharging slit (a space between the electrodes DX, DY), which has a smaller width W3 of about 250 μm for example, than the width W1 in the display electrode pairs 30. The dummy electrode pair 40 and the adjacent display electrode pair 30 (which is the display electrode pair 30 at the end of the effective display area S) are separated by a gap which has a smaller width W4 of about 600 μm for example, than the width W2 of the display electrode pair slit.

As seen in FIG. 4, the dummy electrode DY and the scanning electrode Y(1) of the adjacent display electrode pair 30 have their ends electrically connected with each other by a wiring 50. Also, the dummy electrode DX and the sustaining electrode X(1) of the adjacent display electrode pair 30 have their ends electrically connected with each other by a wiring 51. The wirings 50, 51 are formed by patterning during the same formation process as for the bus electrodes 302 and the metal electrodes 402. It should be noted here that the inner surface of the front plate 20 is formed with a dielectric layer 13 as necessary, to cover the display electrode pairs 30 and the dummy electrodes 40.

As seen in FIG. 1 through FIG. 3, the back plate 21 has an inner surface formed with a plurality of addressing electrodes A across the display electrode pairs 30 and the dummy electrode pair 40, in a direction along the discharge tubes 10. The addressing electrodes A are formed, for example, by first making a film of a highly conductive metal such as copper by means of vapor deposition or spattering, and then removing unnecessary part by etching. It should be noted here that each electrode in the display apparatus 1 is connected with an unillustrated drive IC (a drive circuit) for voltage application. Specifically, there are a first drive IC for applying a voltage to each of the addressing electrodes A, a second drive IC for applying a voltage to the dummy electrode DX and all of the sustaining electrodes X, and a third drive IC for applying a voltage to the dummy electrode DY and all of the scanning electrodes Y.

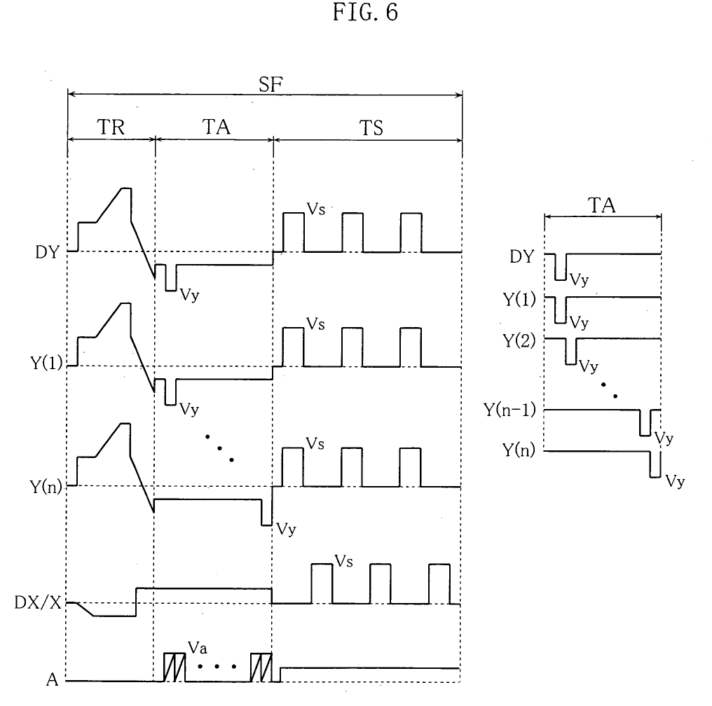

When displaying images using the display apparatus 1 of the above-described configuration, an ADS method is employed. Specifically, one frame is divided into e.g. eight sub-fields which are given a luminance weight. FIG. 6 is a drive waveform chart of a sub-field SF. The sub-fields SF is composed of a reset period TR, an address period TA and a sustain period TS.

The reset period TR is a period in which wall charges in the dummy line and in all of the display lines are erased in order to cancel any influence from the previous light emission state. In the reset period TR, a resetting voltage is applied concurrently across the dummy electrode DX and the dummy electrode DY as well as across all pairs of the sustaining electrode X and the scanning electrode Y, whereby unnecessary charges in any of the light emitting cells are erased.

The address period TA is a period in which addressing discharges are generated in accordance with display data in those light emitting cells selected for light emission, and wall charges are accumulated in these light emitting cells. In the address period TA, the dummy electrode DX and the sustaining electrodes X are biased to a positive potential with respect to the grand potential. Under this state, a negative scan pulse voltage which has a crest value Vy is applied sequentially (scanning is made) to the scanning electrodes Y, from the endmost display line on one side of the effective display area S toward the endmost display line on the other side (the scanning direction is indicated by an arrow in FIG. 4). Specifically, referring to FIG. 4, a scan pulse voltage is applied to the scanning electrode Y(1) in the uppermost display line (scanning-start line) at the beginning of the address period TA, whereas a scan pulse voltage is applied to the scanning electrode Y(n) in the lowermost display line (scanning-end line) at the end of the address period TA. In the present embodiment, since the dummy electrode DY and the scanning electrode Y(1) are connected with each other by the wiring 50, the scan pulse voltage application to the dummy electrode DY and the scan pulse voltage application to the scanning electrode Y(1) are simultaneous. In synchronization with the scan pulse voltage application, a positive address pulse voltage which has a crest value Va is applied to those addressing electrodes A which are associated with the light emitting cells selected for light emission. Now, in these light emitting cells which are given the address pulse voltage, an addressing discharge is generated across the addressing electrode A and the dummy electrode DY/the scanning electrode Y, resulting in accumulation of a wall charge. Since the dummy electrode DX and the sustaining electrodes X are biased to the same positive potential as the address pulse voltage, the address pulse voltage is cancelled and therefore there is no discharge across the dummy electrode DX/the sustaining electrodes X and their addressing electrodes A.

The sustain period TS is a period in which the selected light emitting cells are allowed to emit lights. In the sustain period TS, a sustaining pulse voltage of a positive crest value Vs is applied alternately to the dummy electrode DY/all of the scanning electrodes Y and the dummy electrode DX/all of the sustaining electrode X while all the addressing electrodes A are biased to a positive potential with respect to the grounding potential in order to prevent counter discharge. As a result, all but only those light emitting cells which have an accumulation of wall charge discharge make emission of light. The number of sustaining pulses applied during the sustain period TS is determined in accordance with the luminance weight in the sub-fields SF.

By the execution of all of these operations in the reset period TR, the address period TA and the sustain period TS, one sub-field SF is completed, and by repeating a set of eight sub-fields SF, one frame is displayed. In this arrangement, gradation display in three RGB colors is possible by controlling the number of discharge light emissions by the sustaining pulse in each light emitting cell. Then, by repeating the frame display cycle, a motion picture is displayed on the front surface of the plate 20.

According to the present embodiment, a scan pulse voltage is applied to the dummy electrode DY simultaneously with the scanning electrode Y(1) of the scanning-start line in the addressing operation in the address period TA. During such a simultaneous addressing operation performed to two lines, i.e. to the dummy line and to the scanning-start line, as described, mutual supply of priming particles takes place between adjacent cells in the two lines to give rise to a priming effect. Therefore, an addressing discharge in the scanning-start line occurs at an increased probability. It should be noted here that since the dummy line and the scanning-start line are scanned simultaneously, the dummy line (the dummy electrode pair 40) does not increase the length of address period TA.

Also, since the width of the metal electrode 402 as a composite of the dummy line (the dummy electrode pair 40) is wider than that of the bus electrode 302 of the display electrode pair 30, the discharge starts at a lower voltage and at an earlier timing (with a shorter discharge delay) in the dummy line than in the scanning-start line. As a result, the dummy line has an increased probability for an addressing discharge to take place than the scanning-start line. With the increased probability for addressing discharge in the dummy line (the dummy electrode pair 40) as described, then, there is an appropriate supply of priming particles to the adjacent scanning-start line, and the scanning-start line has an increased probability for an addressing discharge. With the increased probability for addressing discharge in the scanning-start line, there is an appropriate supply of priming particles to the adjacent display line. This is repeated as the addressing operation continues and sequential supply of priming particles to the adjacent display line continues. As a result, an addressing discharge take place stably in all of the display lines in the effective display area S, resulting in effective prevention of the discharge failure in the area S.

According to the present embodiment, the width W4 of the gap between the dummy electrode pair 40 and the adjacent display electrode pair 30 serving as the scanning-start line is narrower than the width W2 of the display electrode pair slit. Also, the dummy electrode Y1 and the scanning electrode Y(1) of the scanning-start line are disposed adjacently to each other. Specifically, the distance between the dummy electrode DY, which is involved in addressing discharge, and the scanning electrode Y(1) is much smaller than the distance between two scanning electrodes Y in mutually adjacent display lines. Therefore, at the time of addressing operation, supply of priming particles from the dummy line to the scanning-start line takes place more reliably. This works favorably for increased probability for an addressing discharge to take place in the scanning-start line.

According to the present embodiment, the width W3 of the discharging slit in the dummy electrode pair 40 is smaller than the width W1 of the discharging slit in the display electrode pairs 30 and therefore, erasure of wall charge by application of a resetting voltage takes place more appropriately. This is favorable in preventing such a problem as error discharge and in allowing an addressing discharge to take place more appropriately.

According to the present embodiment, the metal electrode 402 which does not allow light to pass through in the dummy electrode pair 40 is formed to have a large width. According to such an arrangement, the dummy electrode pair 40 can have a function as a light shielding film.

Also, According to the present embodiment, the dummy electrode DY and the scanning electrode Y(1) are connected with each other via the wiring 50, whereby voltage application to these electrodes takes place simultaneously. Likewise, the dummy electrode DX and the sustaining electrode X(1) are connected with each other via the wiring 51, whereby voltage application to these electrodes takes place simultaneously. With such an arrangement, therefore, there is no need for making changes in the drive ICs which are connected to the electrodes, as compared to a case where there is no dummy electrodes DX, DY provided.

Thus far, an embodiment of the present invention has been described, but the scope of the present invention is not limited to the embodiment so far described. Specifics of the three-electrode surface discharge display apparatus according to the present invention may be changed in many ways within a range of spirit of the present invention. For example, the present invention is applicable to other types of three-electrode surface discharge display apparatuses such as PDPs (plasma display panels) which are different in configuration.

In the embodiment, the dummy electrode DY and the scanning electrode Y(1) of the adjacent display line are connected with each other by the wiring 50. However, the electrical connection may be provided by different means. For example, the dummy electrode DY and the scanning electrode Y(1) may be connected by a drive circuit.

Also, the number of the dummy electrode pair which is provided outside the effective display area may be two or more. It should be noted here that if the effective display area is divided into two smaller areas (a first and a second partial display areas) and an addressing operation is made to the two areas separately and simultaneously, a dummy electrode pair may be provided individually for each area, one provided outside of the first partial display area and another provided outside of the second display area. In this case, the addressing operation may be started from the endmost tube in each of the first and the second partial display areas toward the center, in order to provide each of the partial display areas with the same advantages as described in the above embodiment.

1. A three-electrode surface discharge display apparatus comprising: a discharge tube group including a plurality of discharge tubes extended straightly for a predetermined length in parallel to each other thereby providing a panel as a whole; a plurality of display electrode pairs disposed on one surface-side of the discharge tube group across a longitudinal direction of the discharge tubes, each display electrode pair including a scanning electrode and a sustaining electrode laid in parallel to each other and spaced by a discharging slit of a predetermined width; and addressing electrodes each disposed along one of the discharge tubes on another surface-side of the discharge tube group; wherein:
each pair of mutually adjacent display electrode pairs provides a display electrode pair slit of a predetermined width, the discharge tube group and the display electrode pairs providing an effective display area;
the three-electrode surface discharge display apparatus further comprises a dummy electrode pair provided outside the effective display area, along an endmost display electrode pair on a side of the effective display area, the dummy electrode pair including a first and a second electrodes corresponding to the scanning electrode and the sustaining electrode respectively; and
the first electrode and the scanning electrode in the endmost display electrode pair are electrically connected with each other.

2. The three-electrode surface discharge display apparatus according to claim 1, wherein the scanning electrode and the sustaining electrode in each of the display electrode pairs respectively include: a relatively wider transparent electrode; and a relatively narrower and electrically more conductive bus electrode disposed along a far side of the transparent electrode away from the discharging slit,
the first and the second electrodes in the dummy electrode pair including a metal electrode having a better electrical conductivity than the transparent electrode,
the first electrode being wider than the bus electrode.

3. The three-electrode surface discharge display apparatus according to claim 1, wherein the dummy electrode pair has a discharging slit which is narrower than the discharging slit in the display electrode pairs.

4. The three-electrode surface discharge display apparatus according to claim 2, wherein the dummy electrode pair has a lower visible light transmissivity than the display electrode pairs.

5. The three-electrode surface discharge display apparatus according to claim 1, wherein the first electrode and the scanning electrode in the endmost display electrode pair are connected by a wiring.

6. The three-electrode surface discharge display apparatus according to claim 1, wherein the first electrode and the scanning electrode in the endmost display electrode pair are connected by a drive circuit.

7. The three-electrode surface discharge display apparatus according to claim 1, wherein a gap between the dummy electrode pair and the endmost display electrode pair is narrower than the display electrode pair slit.

8. The three-electrode surface discharge display apparatus according to claim 1, wherein the first electrode and the scanning electrode in the endmost display electrode pair are disposed adjacently to each other.

9. A three-electrode surface discharge display apparatus comprising: a discharge light emission element group including a plurality of discharge light emission element group extended straightly for a predetermined length in parallel to each other thereby providing a panel as a whole; a plurality of display electrode pairs disposed on one surface-side of the discharge light emission element group across a longitudinal direction of the discharge light emission elements, each display electrode pair including a scanning electrode and a sustaining electrode laid in parallel to each other and spaced by a discharging slit of a predetermined width; and addressing electrodes each disposed along one of the discharge light emission elements on another surface-side of the discharge light emission element group; wherein:
each pair of mutually adjacent display electrode pairs provides a display electrode pair slit of a predetermined width, the discharge light emission element group and the display electrode pairs providing an effective display area;
the three-electrode surface discharge display apparatus further includes a dummy electrode pair provided outside the effective display area, along an endmost display electrode pair on a side of the effective display area, the dummy electrode pair including a pair of a first and a second electrodes corresponding to the scanning electrode and the sustaining electrode respectively;
the first electrode and the scanning electrode in the endmost display electrode pair are electrically connected with each other.
